(19) United States
(12) Patent Application Publication
(10) Pub. No.: US 2021/0383432 A1
(43) Pub. Date: Dec. 9, 2021

(54) SYSTEM AND METHOD FOR INTERACTIVE BUSINESS PROMOTION BASED ON ARTIFICIAL INTELLIGENCE

(71) Applicant: Stephen Madison Byrd, Upper Marlboro, MD (US)

(72) Inventor: Stephen Madison Byrd, Upper Marlboro, MD (US)

(21) Appl. No.: 17/408,858

(22) Filed: Aug. 23, 2021

Related U.S. Application Data
(63) Continuation-in-part of application No. 16/823,370, filed on Mar. 19, 2020.

(51) Int. Cl. G06Q 30/02; G10L 15/08

(52) U.S. Cl. CPC G06Q 30/0261; G10L 15/08; G06Q 30/0257

(57) ABSTRACT

The present invention is a platform for interactive business promotion based on artificial intelligence (AI). It discloses a voice-based digital assistant system for displaying location based business deals, offers or promotions to the customers. The AI based interactive platform comprises of, mainly a graphical user interface, processor coupled with memory and a GPS enabled location mapping for offering live business deals, offers or promotions. The system filters out expired business deals or offers by providing updated and latest information to the customers.

### CROSS REFERENCE TO RELATED APPLICATIONS

The present application is a Continuation-In-Part application of U.S. patent application Ser. No. 16/823,370 filed on 19 Mar. 2020.

### FIELD OF INVENTION

The present invention relates to Artificial Intelligence based informative digital assistant system, more particularly, voice-based digital assistant system for displaying live business deals, offers or promotions to the customers.

### BACKGROUND OF THE RELATED ART

No matter what kind of business you are, it's the rise of digital marketing. These online strategies are the ways in which companies can grow and expand. Virtual Marketing Assistants are a cost-effective, convenient way to leverage the expertise of an experienced marketing professional. For businesses, digital assistants provide a single, convenient point of contact for contractors and customers.

Digital assistants are most commonly used in customer contact centers to manage incoming communication. Digital assistants are complex and are backed with Artificial Intelligence. Especially, the use of Artificial Intelligence and Machine Learning helps customers to check live offers or business deals within a given geographical area hence customizing the end user experience.

### DESCRIPTION OF RELATED ARTS

US granted patent, U.S. Ser. No. 10/043,516B2 discloses an automated voice-based system for intelligent assistant. It is an information processing system that interprets natural language input in spoken and/or textual form to infer user intent, and performs actions based on the inferred user intent. In another prior art, bearing patent number, U.S. Ser. No. 10/909,980B2, it discloses methods, systems, and computer-readable mediums having instructions for implementing machine-learning digital assistants for advanced analytics, procurement, and operations tasks.

‘Bharath et al.’ in a US granted patent U.S. Pat. No. 9,047,631B2, discloses a method and system for providing location based customer assistance. This patent, more particularly, teaches about the method for providing a distributed mobile call center for a service establishment. 100071 In yet another patent application, US20130311286A1, John et al., claims a system and method for facilitating determination of marketing information for online consumers based on a location characteristic of the online consumer. Further, Westley et al. in the granted patent U.S. Ser. No. 10/672,066B2, teaches about digital assistant that interacts with the owner's mobile device.

In yet another patent application, bearing application number US20210134263A1, Victor et al. discloses a platform and system for the transcription of electronic online content from mostly visual/text format to an aural format, adapted for being read by an intelligent speaker system. It specifically discloses an automated engine with artificial intelligence and/or machine learning for the transformation of written websites into audioenabled content for use in association with new technology intelligent speakers, for implementing data mining, processing, and summarizing tools.

Another granted patent to Apple Inc., U.S. Pat. No. 9,548,050B2 filed by Thomas et al. teaches about an intelligent automated assistant system that engages with the user in an integrated, conversational manner using natural language dialog, and invokes external services when appropriate to obtain information or perform various actions.

None of the above discussed prior arts teaches about informative voice based, AI enabled digital assistants specifically meant for displaying location based live business deals, promotions or offers as per customer interests and preferred geographical locations.

### SUMMARY OF THE INVENTION

The embodiments of the present invention discloses a system and method for displaying live offers, promotions and business deals in a given geographical area.

In another embodiment of the present invention, the system recommends only location specific live business deals or offers based on customer's GPS enabled location mapping.

Yet another embodiment of the present invention discloses an informative system and method of accepting voice commands to process the search query of the user and displaying live business deals, promotios or offers within a given geographical area using GPS enabled location mapping.

In yet another embodiment of the present invention, the system filters any expired business deals or expired offers thereby keeping the latest information on the user display.

In yet another embodiment of the present invention, the system additionally accepts text based search query for displaying live business deals or offers within a given geographical area using GPS enabled location mapping of the user.

In still another embodiment of the present invention, the system provides live offers or business promotions based on customer's area or zip code, GPS location, or nearby landmarks.

### BRIEF DESCRIPTION OF THE ACCOMPANYING DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 illustrates a typical network diagram embodying the present invention.

FIG. 2 illustrates yet another embodiment of the disclosed invention representing the system flow.

FIG. 3 illustrates the block diagram of the AI based digital voice assistant

FIG. 4 illustrates the flowchart depicting the method of the disclosed invention.

FIG. 5 illustrates an exemplary screenshot of the search page of the present invention in a mobile device

FIG. 6 illustrates another exemplary screenshot of the analytics interfaces of the present invention.

FIG. 7 illustrates an exemplary screenshot of the rating system of the present invention.

FIG. 8 illustrates an exemplary screenshot of the user interface showing business listings.

### DETAILED DESCRIPTION OF THE PREFERRED EMBODIMENTS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular embodiments only and is not intended to be limiting. As used herein, the singular forms “a”, “an” and “the” are intended to include the plural forms as well, unless the context clearly indicates otherwise.

With reference to the use of the words “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and the following claims.

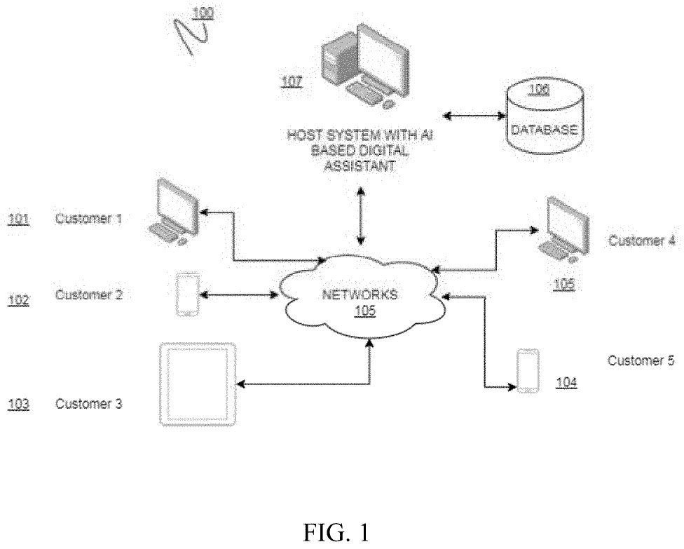

The present invention discloses an interactive Artificial Intelligence enabled digital voice based assistant system that helps customers to receive location based live business deals, promotions or offers. FIG. 1, shows a typical network diagram embodying the present invention. FIG. 1 illustrates a system 100 that gives an overview of how the present invention works. The system (100) includes a host (107) wherein interactive digital assistant system is hosted with supportive database (106). Various customers (101,102,103,104,105) from different locations access the host system (107) via a general purpose network (105) by means of any communication devices such as computer, mobile, portable tab or laptop etc. Any of these customers may access the digital assistant system and execute voice commands to know about the latest business deals. The host (107) processes the customer requests by retrieving data from the databases in response to the executed input voice command. The database (106) store merchant information along with latest offers, promotions, and live deals within a given geographical area, executed and displayed to the customer interface.

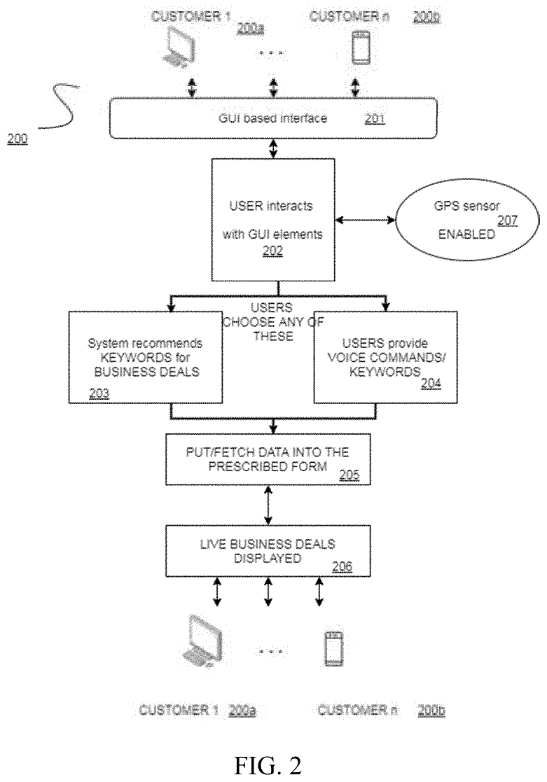

FIG. 2 further describes and illustrates the system 200 representing how the overall system works. Customers through different communication channels (200a, 200b) access the graphical user interface (201). The customers further interact with the graphical user interface of the system 200, wherein the user enabled their global positioning system or GPS (207). The activation of GPS helps customer to receive live business offers or deals based on their current location coordinates. The customer can search for business deals or offers by choosing either the keywords recommendation offered by the system (203) or the customer themselves can provide voice commands or voice keywords (204). The system converts the retrieved input data into a prescribed format (205) Finally, the latest business deals are displayed (206) to the customers communication channels (200a, 200b).

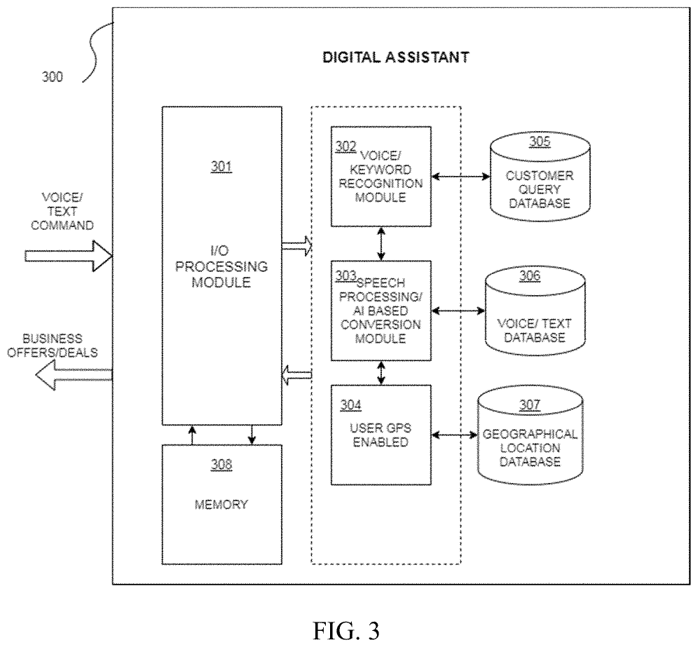

FIG. 3 illustrates a block diagram of the voice based digital assistant. In one embodiment it depicts a computing device 300, which includes input-output processing module (301), memory storage (308) device. More particularly, it consists of AI based speech conversion module (303) that performs machine learned speech recognition and conversion processes. The input command such as voice or text based command is fetched to the digital assistant which is well received and recognized by the voice/keyword recognition module (302), it is then processed by the speech processing module (303) which processes information from the database in response to the voice command received. The processed information is further output back to the input-output processing module (301).

The system (300) also has a global positioning unit (304) that helps the system to process out location based business deals or offers for the customer. For processing voice or textual user commands, the system stores the data or information in databases. The system 300 utilizes databases: customer query databases (305), Voice/text database (306) and geographical location database (307). Customer query databases (305) stores customer queries that the customer wishes to search for. The speech processing module (303) extracts and stores data in this database for voice command processing. Voice/text database (306) stores speech and text commands of the customer requests. This data is fetched or extracted by the AI enabled speech processing module (303). Further the system stores geographical data pertaining to live business deals or offers into geographical location database (307), this is used by the system so as to retrieve and display location based business deals or offers to the customers.

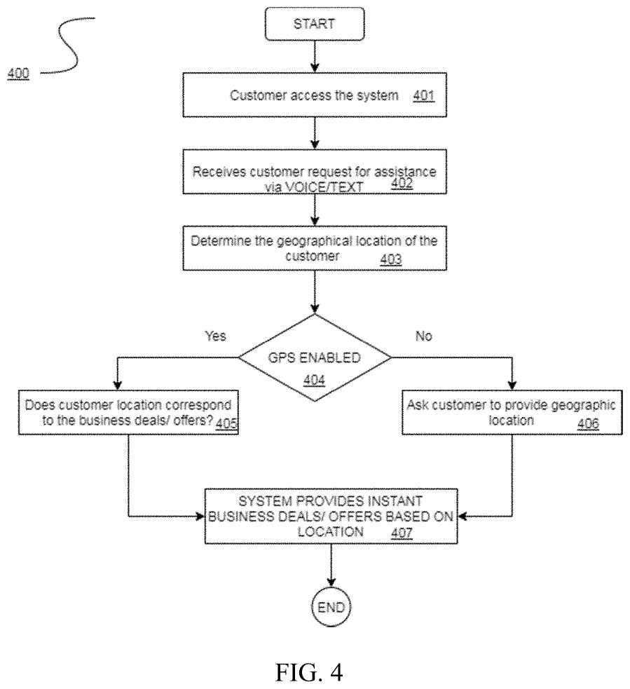

FIG. 4 illustrates the flowchart (400), describing the method which is implemented in the disclosed invention. The customer access the system at (401). The system then receives customer request for assistance via. voice or text commands at (402). The system then determines the geographical location of the customer at (403) by first checking whether the GPS is enabled in the customer device or not (404). If the GPS is enabled, the system checks and updates for latest business deals or offers at (405) else the system asks for the customer's geographical location at (406). The system outputs location based live and instant business deals or offers to the customers at (407).

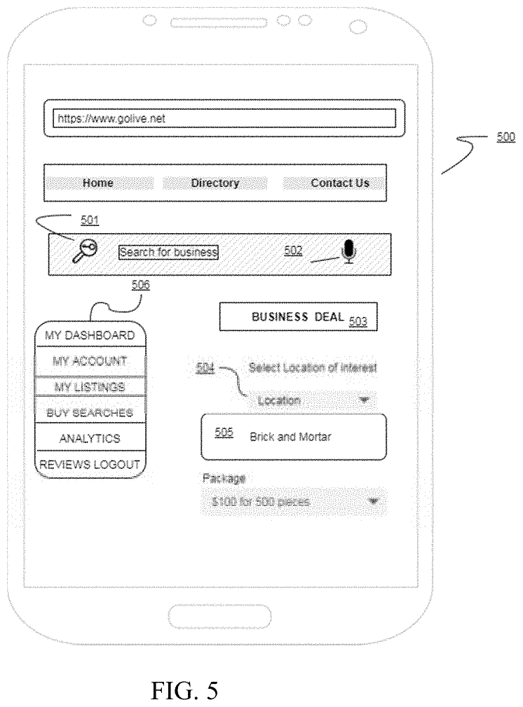

In yet another embodiment of the present invention, it discloses voice based digital assistant for marketing offers or business deals. FIG. 5 illustrates an exemplary screenshot (500) of the present invention in a portable mobile device. Customer can either use the text command using search icon (501) or it is also supported by AI based voice or speech recognition system which can be achieved by clicking the mic icon (502). The home page also provides with dashboard items (506) that lists customer account, previous searches, previous bought item lists, analytics of the searches done etc. The users of the system can check location based business deals by selecting business deals icon (503) and can also select their current geographical location or location of interest (504). business deals that.

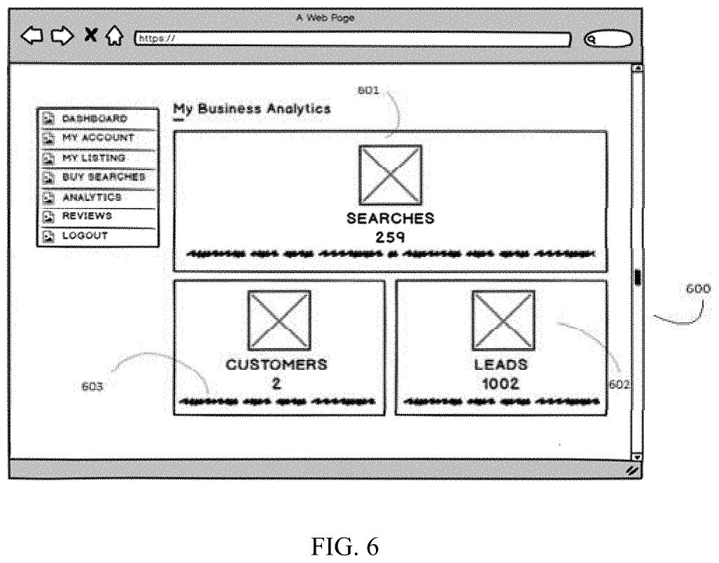

FIG. 6 illustrates an exemplary screenshot of the analytics module (600) of the present invention. It shows the screenshot of the system that displays the business analytics or statistics of the business, comprising the information on how many times the business got searched (601) by the customers or users online, number of reviews left by the customers (603) and number of visitors (602) who visited a specific business deal or website. The present invention comprising the analytics search results displays the list of users who visited a business deal or website along with their IP addresses and date of visiting a particular business deal or website.

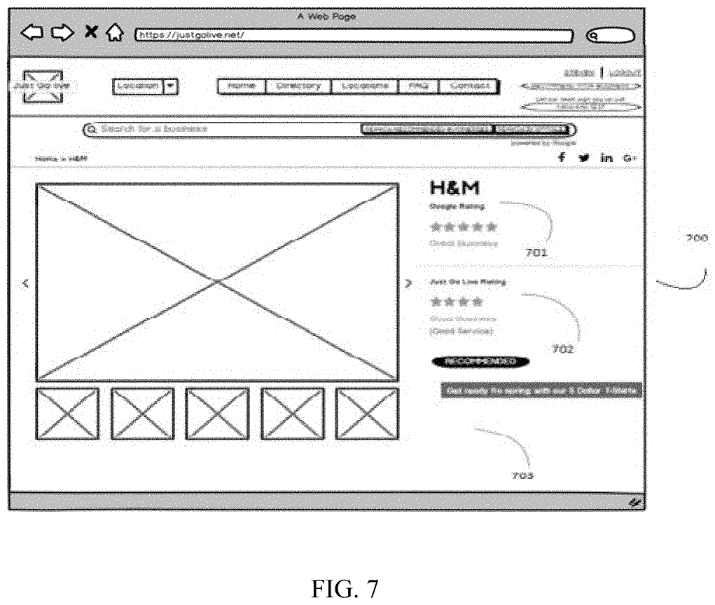

In another embodiment of the present invention, the system offers ratings of the previous business deals and reviews. FIG. 7 illustrates an exemplary screenshot of the rating system of the present invention. It is yet another embodiment of the present invention describing ratings of a business web page (702) of the present system as well as Google rating (701) of a particular business. The meta search engine can display both the Google rating and present search engine's rating. The search engine of the present invention has different and novel rating system where the business can be rated and displayed as good business, average business and poor business.

The present invention also describes pay for customer system where business owners can recommend their business by simply buying searches through pay per customer search system. The pay per customer search system allows business owners/representatives to showcase their business alongside the other businesses by showcasing instant deals. The business owner/representative can choose how many searches they want and set keywords in the system representing their deals. Therefore each time a user inputs a query comprising those keywords; the relevant business deal is displayed by the system. Each time the relevant business deal is displayed, the total number of searches in the package opted by the business deducts accordingly. Whenever a user search a keyword, the present system records the number of times a specific keyword has been searched by the user. The present system analytics also gathers information such as who searched the keyword, location of the user searching the keyword, date on which the keyword was searched. The present search engine is configurable such that it may be integrated with third party applications also.

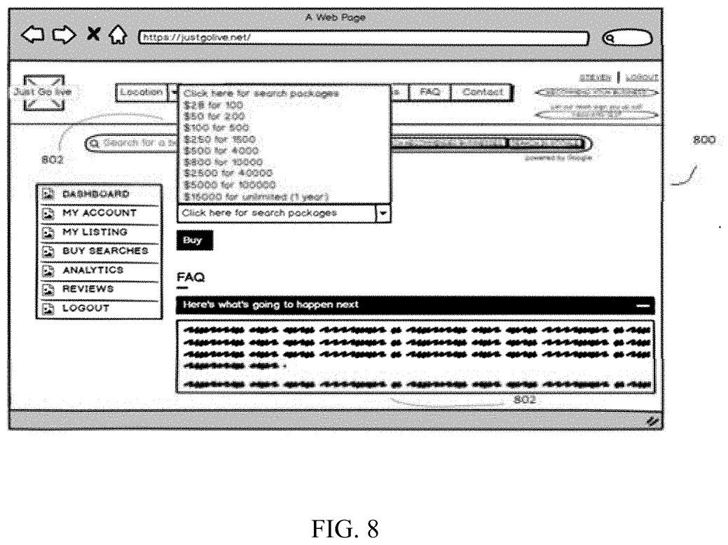

FIG. 8 illustrates an exemplary screenshot of the user interface (800) showing business deals listings and search packages (802). The present invention shows the user interface displaying various “search packages” (802) offered to the businesses inclined to showcase their business deals to the customers using the present invention.

While a number of preferred embodiments have been described, it will be appreciated by a person skilled in the art that numerous variations and/or modifications may be made in the invention without departing from the spirit or scope of the invention as broadly described. The present embodiments are, therefore, to be considered in all respects as illustrative and not restrictive. The words “customer” and “user”,“AI” and “artificial intelligence” and “webpage” and “websites” have been used interchangeably in the above discussed specification. Therefore, the present invention is not limited to the above embodiments that the person should be made under the inspiration of this novel utility of the present invention the same or similar technical solution has, fall within the scope of the present invention.

I/We claim:

1. A system comprising:
a network interface coupled to an artificial intelligence based digital assistant;
a network interface coupled to various computing devices of the customers;
a digital assistant configured to receive and recognize audio commands from the user;
a digital assistant coupled to database storing merchant information;
a digital assistant retrieving data from merchant database based on the voice input command by the user.

2. A system according to claim 1 wherein, the merchant information comprise latest offers, business promotions, and live deals within a given geographical area of the user.

3. A system according to claim 1, comprising one or more processors and memory to communicate with the network interface and merchant database.

4. An interactive digital assistant comprising:
interactive graphical user interface to communicate with the users;
at least one microphone to receive audio input from the user;
at least one typing element to receive text input from the user;
a global positioning system to receive current location of the user;
a keyword recognition module to process text based commands from the user;
a speech processing module to process voice commands from the user.

5. A method comprising:
receiving request for assistance via plurality of communication device of the user;
fetching geographical location of the user with the help of GPS enabled user device;
presenting live business promotions, deals and offers to the user via a plurality of communication device.

6. A method according to claim 5, wherein:
receiving request for assistance comprise receiving either voice or text commands from the user;
fetching geographical location of the user for presenting live deals, promotions and offers around the vicinity of the user.

7. A method according to claim 5, wherein:
interactive graphical user interface to communicate with the users;
at least one microphone to receive audio input from the user;
at least one typing element to receive text input from the user;
a global positioning system to receive current location of the user;
a keyword recognition module to process text based commands;
a speech processing module to process voice commands from the user.
